(19) United States
(12) Patent Application Publication
(10) Pub. No.: US 2009/0132480 A1
(43) Pub. Date: May 21, 2009

(54) Data recording format and methods using it

(76) Inventor: Jean-Marc Liron, Morlaix (FR)

Correspondence Address: Blakely Sokoloff Taylor & Zafman, 1279 Oakmead Parkway, Sunnyvale, CA, 94085-4040, US

(21) Appl. No.: 11/921,729

(22) PCT Filed: Jun. 5, 2006
(86) PCT No.: PCT/EP2006/062907

§ 371 Date: Dec. 19, 2008

(30) Foreign Application Priority Data
Jun. 6, 2005 (EP) 05/05693

(51) Int. Cl. G06F 17/30

(52) U.S. Cl. 707/3; 707/100; 707/E17.044; 707/E17.014

(57) ABSTRACT

The invention relates to a format for data recording in a computer memory (M), in which a multiplicity of data elements (E) associated with a multiplicity of respective data elements identifiers (IE) are defined.

According to said invention, the format is characterized by metadata comprising at least one recorded link (L) of a first identifier of the first data element, referred to as source element, to a second identifier of a second data element, referred to as target element, in a centalized link recording table (TB), interrogatable for accessing to the data elements stored in the memory (M).

Said invention can be used for recording, reading, retrieving, transmitting and updating extensive data items.

### TECHNICAL FIELD

The invention is concerns storing data into a computer memory.

### BACKGROUND

An application field of the invention is any kind of extensive databases.

The invention particularly aims to solve a technical problem referring to the reduction of the whole time required for the consultation of extensive databases.

Most often, the database is managed by a server which enables reading data from the base, as well as storing new ones and updating them.

A network enables several remote machines to get connected to the server, so as to enable them to consult the base by addressing reading requests to the server. Then the server analyses the reading request received from a machine in order to read the data that have been stored in the base and to send them back in a response to the machine that sent the request, which is called a requiring machine.

The technical problem raised by large volumes of data is caused by its reading as well as by its writing.

The problem of reading extensive databases is that, even if the content of the response does not use much memory space, the time the server uses to access in the base to the data that were asked in the request can be relatively long and can be multiplied by the number of requests.

Moreover, the content of the response depends on the way the data are organized inside the base.

Thus, the largest the volume of the data stored into the base or more generally into a memory is, the longer is the time to access specified data.

A large volume of stored data makes also difficulties while browsing by successive requests inside them. Indeed, these data are then hard to find and to handle, especially since the whole time of response not only includes the time of search and of data processing that is executed by the various machines, but also the times spent by the user in analysing the received responses and in conceiving and typing the following questions.

The usual search engines such as Google make a quick literal search, but bring out a very long list of results, yet the user has to analyse these results by reading them one by one, which is tedious and brings mistakes.

The organization of data stored by a user is essential so that he or another user could easily and quickly find requested data. Nevertheless, some stored data often happen to be unfound, because they have been recorded in the wrong folder. More generally, some data may be hard to file in one folder or another, and an arbitrary choice may be made, which jeopardizes the chances of quickly finding the data afterwards.

The information management systems that contain data and electronic documents are universally used tools. They are often known as having a vital importance for the activities and communications in most fields, in personal as in collective uses. The fast and constant growth of compiled data volumes leads to significant problems which are poorly managed. Today, the users only have restricted and insufficient means to sort and to organize, even sometimes to find back data and documents that they compile.

The electronic documents are routinely used and stored by means of computer programs, either by operating systems such as, for example, the Windows system explorer, the Mac OSX Finder, or by using mailing software programs such as Outlook, Outlook Express, Lotus Notes, Thunderbird (registered trademarks), or also by the use of applications which are specialized in the processing of pictures, sounds, videos and more.

Moreover, most of the software programs are based upon conception principles that have been established when the volumes of documents were relatively small. Today, the explorers that are integrated to operating systems open the possibility, for example, of filing the documents in separate folders belonging to a hierarchical structure. The user has to manage this hierarchy himself, he has to create folders and put them inside other folders, where he has the possibility of saving, copying or erasing the documents. In terms of time, this activity of classifying happens to be a significant workload, especially when there are numerous files, which often happens while receiving e-mails, website copies or downloaded files.

A fundamental flaw of this hierarchic sorting based on folders and sub-folders is that a document, or a folder, can belong to only one folder. This limitation leads to arbitrary decisions, when it is necessary to choose among two or several folders that could be appropriate for the same document or folder. For instance, should the 2005 Maintenance budget of fire extinguishers be classified in the Budget folder, the Maintenance folder, the Fire security folder or the 2005 folder?

Although a user can place copies of a document or of a folder inside several folders, later he has to manage these copies independently. This leads to using additional storage space and to possible discrepancies between originally similar data, when one of the copies gets modified. This practice leads to overloaded files that are uncoordinated, due to a growing number of documents that a user accumulates as time passes by.

To overcome these drawbacks, shortcuts have been created, which enables linking specifically one folder to another without duplicating the information. However, the visualization of the organization remains mediocre, and this system demands a daily effort from the user to manage it, this effort being too significant for a generalized use. It is the reason why this artifice is used in a limited, even rare manner.

Besides, once a document has been classified, finding it back afterwards can happen to be hard, especially if there are several folders in which the document could have been placed, and this brings discomfort and inefficiency to the user.

Some documents management, e-mail or script software programs enable the user to filter the incoming mails or the existing documents by applying a series of rules to them, either automatically, or caused by the user. For instance, the common version of the Outlook software enables the users to create such rules. The U.S. Pat. No. 6,057,841 and U.S. Pat. No. 5,377,354 documents outline some filtration mechanisms of this type.

Though the use of rules may bring a powerful help, yet it introduces noteworthy difficulties. Indeed, their principles are to apply a series of instructions to each document in order to specify its affectation. If the number of rules is above a relative small number, the whole system gets very hard to understand. Besides, the manual typing of all of these rules on a keyboard involves a significant effort, which explains that most users give up on a significant use of these tools.

The software suppliers, aiming to help the users in organizing their data sets, made other means of action available, such as keywords (also called categories), bookmarks, in particular in Internet explorers, and tags (also called flags or labels). These powerful means of action facilitate the handling of documents, but they are less powerful than filtration rules. It requires typing efforts on the keyboard so as to type the keywords, and it happened to be inadequate in the management of large volumes.

The keywords and labels enable the user to highlight some documents so as to distinguish them from the other ones. They have the drawback of not making visible the documents that have been identified outside their belonging folder. The use of these mechanisms gets reduced by the lack of a quick and simple means of finding back all of the documents marked by a label or a keyword and of viewing the location(s).

To solve the problems due to the extended use of hierarchic classification systems, some search tools have been developed, and made available to the public. These are notably known under the commercial reference names of Google Desktop, Spotlight, MSN Search, Copernic and more. The traditional sequential searches happened to be too slow, so systems of textual indexation of the contents have been used, as they work much faster. These tools of indexed search provide a significant help to the user. However, it requires the punctual efforts of thinking of one or several search criterions, to type it down the keyboard, and to have operational knowledge of Boole algebra operators.

The reliability of the executed searches is also affected by the fact that synonyms or translations, even the spelling, in the captured criterions, the texts or titles of documents and of folders are taken into account. The search results themselves can represent a significant volume of chaotic data, which increases the difficulties. A consequence that can be considered as negative, of an extended use of a tool of indexed search, is to suppress any incentive to rigorous filing. The user views the organization of his data less often, therefore he does not improve it, which can lead to a general lack of organization in all of the documents that a user compiles day after day.

The various methods that have been proposed in order to resolve the hierarchic classification issues do not bring entire satisfaction.

Thus, to settle the matters of classifying electronic mails, document U.S. Pat. No. 5,948,058 associates a binary matrix to each electronic mail to define several belonging categories. However, this method has performance problems.

Document U.S. Pat. No. 6,029,164 describes a method to add labels to the messages that are then indexed by an indexation and literal search engine, which has the drawbacks of the literal indexation search methods.

Document WO 99/04344 describes an e-mail management system based on an automatic belonging of the messages to a folder per correspondent, depending on a relational database.

Document US-A-2004/199529 describes a method to organize messages inside folders based on the contents and attributes of the mail, in which shortcuts to access to the mails are created in the folders. Of course this method increases the opportunities of finding back a message thanks to its shortcut in a folder, but it does not make clearer to the user the presentation of the mails in the folders, because of the multiplication of shortcuts in the different folders.

Document U.S. Pat. No. 5,555,403 describes a system of SQL requests generation that enables a non-expert user to simply interrogate a database. However it requires multiple data entries on the keyboard, which remains complicated, and do not enable the user to view the data organization.

So it appears that there is an unsatisfied demand for systems and processes that, in a fast, automatic or semi-automatic way, help the organization of documents, folders and data in a large volume, independently from the size, the age or the physical or logical storage location. Consequently, it must be given to the user some time saving, a clearer vision of his data organization, and a cumulative improvement of his personal knowledge base.

The invention aims at reducing the above issues and notably at reducing the times to access to the data in memory.

For that purpose, a first item of the invention is a format for data recording in a computer memory, in which a multiplicity of data elements respectively associated with a multiplicity of data element identifiers are defined,

the format being characterized by metadata comprising at least one recorded link of a first identifier of a first data element, called source element, to a second identifier of a second data element, called target element, this link being associated to a link identifier recorded in association with the source element identifier and with the target element identifier in at least one link recording centralized table,

at least two types of links being implemented,

each link recording centralized table comprising, at least for a set of several links having a same source element identifier and a same type of links, some hierarchical order numbers respectively recorded with the identifiers of the links of said set,

each link recording centralized table being able to be interrogated by request about each source element identifier according to one determined of the types of links, in order to access in memory to the data elements associated with the target element identifiers corresponding to this source element identifier in at least one link having the same determined type of link, according to an order defined by the hierarchical order numbers of this determined type of link.

So the invention offers a new technological format to save diverse data elements to which a user can wish to access by reading and/or writing thanks to a machine for reading and/or writing in the memory, such as a computer or a mobile phone.

Thereby the table recorded in the memory or the base allows a direct access to the data elements connected by a link to a data element whose identifier is known, with no additional search. So it modifies it the internal operating of the memory reading machine, and accelerates said operating.

The format associated to data elements, including the link table associated to these elements, will have the possibility of being transmitted or saved with these data elements, and eventually also with the data elements to which they are linked by links, or will be able to go through the same processing as these ones. So it will be possible to simultaneously communicate data elements and their organization present in the link table from one machine to another.

The link table, including mainly only identifiers, which for instance can be sequence numbers that can each be encoded on a few bytes, has the asset of being of small size, therefore of being easily storable in the memory, which leaves room to the data elements of any size.

The format according to the invention confers a generalized multiple membership to the data elements, which has the effect that each data element can be linked to several others by links. The system according to the invention generalizes the possibilities of membership or the possibilities of multiple linking between documents, folders, periods, actors and other data elements.

Thereby, this multiple membership or parenting allows an ordered classification of the data elements in the memory through links, while avoiding a purely hierarchic classification that could mislead the elements into predefined filing folders.

Indeed, in the case where a data element can have two possible classifications, the format according to the invention creates two links of this data element towards respectively two other target elements in order to maintain the relationship with these two other target elements, and to allow to find back the data element by interrogating one or the other target element and by coming back to the associated link, while other existing technologies would either choose to file the data element in one folder rather than in another one, which requires an access to the element by this folder and looses the other access possibility, or would duplicate the data element in several folders, which multiplies the space used in memory.

The technological effect of the invention is not only the saving and reading of the data elements in a memory, as it was described above, it is also the automatic creation of documents that do not exist in the data elements in the memory, but that are built from links or successions of links between data elements identifiers, whereby for example these documents can be print.

So the format according to the invention has many applications, such as those of the methods described below. Of course, the invention also refers to systems equipped with means that allows the implementation of each one of these methods.

According to a characteristic of the invention, at least two types of links are provided.

The recording centralized table contains, at least for a set of several links that have a same source element identifier and a same type of links, some hierarchical order numbers respectively recorded with the link identifiers of the set.

The link recording centralized table can be interrogated by request about each source element identifier according to one determinate of the types of links, in order to access in memory to the data elements associated with the target element identifiers corresponding to this source element identifier in at least one link that has the determined type of link, according to an order defined by the hierarchical order number of this determined type of link.

For example, the link recording centralized table contains, at least for a set of links that have a same source element identifier, at least one principal hierarchical order number recorded in association with an identifier for at least one determined link of the whole set and at least one secondary hierarchical order number, inferior to the principal hierarchical order number and each one recorded in association with at least another link identifier of the set.

According to other characteristics of the invention:

For at least one type of links, to each link recorded from a first source element to a second target element having this type of links, another recorded link corresponds, called reciprocal link, having another type of links, from this second element which is source for the reciprocal link, to this first element which is target for the reciprocal link.

At least one link is recorded with some attached data in the recording table.

The data recording format comprises a plurality of modular blocks of attached data elements and, for each modular block, the link recording centralized table whose source element identifier is an identifier of a data element attached to this modular block.

Each data element is attached to a modular block among a plurality of modular blocks, and the link recording centralized table comprises, recorded in association with each link identifier, an identifier of the attachment block of the target element of this link.

Each data element is associated to a recorded semantic identifier and is attached to a modular block recorded among a plurality of modular blocks, and each modular block has its own predefined structure of control of screen display, to display the modular block with the same type of display for each data element attached to this modular block, whereby this type of display provides the display of at least one data field, which is predetermined from each data element and which comprises at least the semantic identifier of this data element.

Each modular block contains several different types of display and a zone of selection of display type among those associated to this modular block, the structure of control of screen display, specific to each modular block, being able to display each data element attached to this modular block according to the type of display of the selection zone.

Each data element is attached to a modular block recorded among a plurality of modular blocks, whereby each modular block comprises means to access to each data element attached to this modular block.

Each data element is attached to a modular block recorded among a plurality of modular blocks, each modular block comprising means to access to at least one data element having as identifier the target element identifier of at least one link, whose source element identifier is the identifier of a data element attached to this modular block.

The links are semantic.

Each data element is associated to a recorded semantic identifier and is attached to a modular block recorded among a plurality of modular blocks, the data elements attached to each modular block are of a same individual semantic category, associated to this modular block,

in association with at least one combination of several modular blocks and for at least one type of links, a predetermined text body is recorded, comprising as variables some semantic identifiers of the data elements of the respective blocks of the combination and able to be printed with, instead of the variables, the semantic identifiers of the data elements of the blocks of this combination, associated to some source and target elements of a sequence of links of the recording table.

One aspect of the invention is also a method to record data in a computer memory, in which a multiplicity of data elements respectively associated with a multiplicity of data element identifiers are defined,

characterized by the fact that the data elements are recorded in the memory with at least one link recorded in a link recording centralized table with the format as described above,

each link being able to be interrogated by request about its source element identifier, in order to automatically access in the memory to at least one data element associated with the target element identifier corresponding to this source element identifier in the link.

According to other features of the invention,

At least one link is created and/or modified in the link recording centralized table by a machine interface, able to be controlled by the user, using for example the method of sliding-dropping.

At least one pre-emptive link is automatically created by means of semantic proximity measurement applied to the data elements and is automatically presented to the user on a machine interface, the interface comprising means to manually activate a control of acceptance or refusal of creation of the presented pre-emptive link,

whereby the receipt by the interface of an acceptance control for a pre-emptive link automatically involves the recording of this pre-emptive link in the link recording centralized table.

At least one link is automatically created by means of semantic proximity measurement applied to the data elements and is automatically recorded in the link recording centralized table.

At least one virtual link, connecting a source element to a target element, or at least one virtual data element, defined by a determinist calculation rule, without being permanently recorded in memory, is provided, whereby the record in memory being exclusively executed by the activation of a corresponding recording control of the virtual link or of the virtual element.

Another aspect of the invention is a method to read data recorded in a computer memory, in which a multiplicity of data elements respectively associated with a multiplicity of data element identifiers are defined,

characterized by the fact that, the multiplicity of data elements being recorded in the memory with at least one link recorded in a link recording centralized table with the format as described above,

the reading access in the memory to at least one first data element whose identifier is a source element identifier which is associated, in at least one link of the recording table, with the target element identifier of at least one second data element automatically activates by request on the identifier of this first data element in the link recording table, the additional access to the second data element.

Another aspect of the invention is a method to search data elements among a multiplicity of data elements recorded in a computer memory,

characterized by the fact that, the multiplicity of data elements being recorded in the memory with at least one link recorded in a link recording centralized table with the format as described above,

a first data element, is selected, which automatically activates, for a first search level going from the first data element, by request on the identifier of this first data element in the link recording table, the access by link to at least one second data element at least when the identifier of the first data element is a source element identifier which is associated, in the same link of the link recording table, with the target element identifier formed by the identifier of the second data element.

According to other features of the invention,

The access to the data elements automatically activates their distinctive and at least partial display on a screen.

The access by link to data elements is executed for a predetermined number of successive search levels that is superior or equal to two,

the access by link to a previous data element executed by a previous search level automatically activates, for the next search level, by request on the identifier of this previous data element in the link recording table, the access by link to at least one next data element, at least when the previous data element identifier is a source element identifier which is associated, in the same link of the recording table, to the target element identifier formed by the next data element identifier.

For at least one next search level, the data element or the data elements for which the access by link to at least one next data element is executed, is selected among the previous data elements.

Said selection of the previous data element or elements for the next search level is automatically executed by means of at least one logical operator applied to at least one subset of the source elements used for the previous search levels.

Another aspect of the invention is a method to transmit data recorded in a computer memory to an output, in which a multiplicity of data elements respectively associated with a multiplicity of data element identifiers are defined,

characterized by the fact that, the multiplicity of data elements being recorded in the memory with at least one link recorded in a link recording centralized table with the format as described above,

at least one first data element to be transmitted to the output is selected in the memory,

in the link recording centralized table the link(s) having as source element identifier the identifier of the first selected data element are automatically searched, at least the link(s) found by said search are automatically transmitted to the output, with the first selected data element.

For example, the data element(s) having the target element identifier of the link(s) found by said search are automatically transmitted to the output with the first selected data element in addition to the link(s) found by said search.

Another aspect of the invention is a method to update a remote computer memory from data recorded in at least one local computer memory, whereby a multiplicity of data elements respectively associated with a multiplicity of data elements identifiers are defined in the remote computer memory and in the local computer memory,

characterized by the fact that, the multiplicity of data elements being recorded in the local computer memory with at least one link recorded in a link recording centralized table with the format as described above,

the update of at least one data element of the remote computer memory from a first data element of the local computer memory involves the automatic search, in the link recording centralized table of the local computer memory, of the link(s) having as source element identifier the identifier of the first data element of the local computer memory as well as the automatic update of a link recording table of the remote computer memory from the link(s) found by said search in the link recording table of the local computer memory.

Another aspect of the invention is a method to print a document, in which a multiplicity of data elements respectively associated with a multiplicity of data elements identifiers are defined in the remote computer memory and in the local computer memory,

characterized by the fact that, the multiplicity of data elements being recorded in the local computer memory with at least one link recorded in a link recording centralized table with the format as described above,

each data element is associated to a recorded semantic identifier and is attached to a modular block recorded among a plurality of modular blocks,

the data elements attached to each modular block are of a same individual semantic category, associated with this modular block,

in association with at least one combination of several modular blocks and for at least one type of links, a predetermined text body is recorded, comprising as variables some semantic identifiers of the data elements of the respective blocks of the combination, at least one first data element is selected in a block of said combination and at least another data element having a link or a sequence of links to the first selected data element is selected in each one of the other blocks of the said combination,

the document with the text body having, instead of the variables, the semantic identifiers of the data elements selected from the blocks of said combination is printed.

### BRIEF DESCRIPTION OF THE DRAWINGS

The invention will be better understood while reading the following description, which is only given as a non-limiting example referring to the annexed drawing, upon which:

FIG. 1 shows a broad outline of the data recording format according to the invention,

FIG. 2 shows a broad outline of some modular block to which are attached some data elements in the format according to the invention, and

FIG. 3 shows a broad outline of a link recording table provided in the format according to the invention,

FIG. 4 represents an embodiment of a selection zone for a type of display provided in a modular block,

FIG. 5 represents an example of modular blocks,

FIG. 6 represents another embodiment of a selection zone for a type of display provided in a modular block, and

FIG. 7 represents another example of modular blocks.

### DETAILED DESCRIPTION

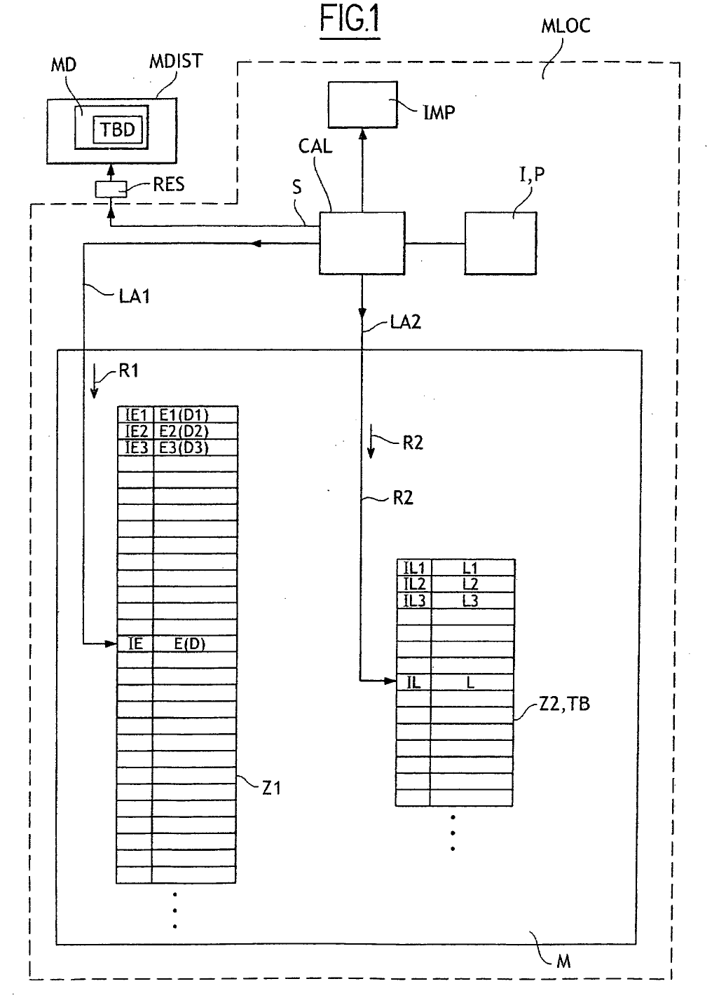

On FIG. 1, a computer memory M is represented, that is for instance the memory of a computer MLOC, such as that of a personal computer or of a mobile phone or of a data base. Of course, the computer memory M could be divided upon several physical memory of several separate machines.

This memory M comprises a first memory zone Z1 for the recording of the data elements E1, E2, E3 designated by the general reference sign E, and a second memory zone Z2 for the metadata recording.

Some means of control CAL, formed for example by a central processing unit, a processor or a calculator, are provided to control the memory M and to access the data elements E, E1, E2, E3 by reading and/or writing, thanks to a link LA1 to access the first memory zone Z1.

The data elements E can be of any form, and for example computer documents. Each data element E, E1, E2, E3 comprises a individual identifier IE, IE1, IE2, IE2 in the memory M, which enables to access to the data D, D1, D2, D3 contained in these data element E, E1, E2, E3. For instance, the access line LA1 comprises an addressing bus running from the control means CAL to the memory M, whereby the identifiers IE, IE1, IE2, IE3 of the data elements E, E1, E2, E3 are, for instance, sequence numbers leading to the physical address of the data elements E, E1, E2, E3 strictly speaking in the zone Z1 of the memory M.

The second memory zone Z2 comprises a link recording centralized table TB for the links L1, L2, L3, designated by the general reference sign L. Each link L, L1, L2, L3 comprises an individual identifier IL, IL1, IL2, IL3 in the memory M. The control means CAL comprise an access line LA2 to the different fields of the links present in the recording table TB, whereby for example this line LA2 also comprises the addressing bus running from the control means CAL to the memory M, the identifiers IL, IL1, IL2, IL3 of the links L, L1, L2, L3 being then for example some sequence numbers leading to the physical address of the links L, L1, L2, L3 strictly speaking in the zone Z2 of the memory M.

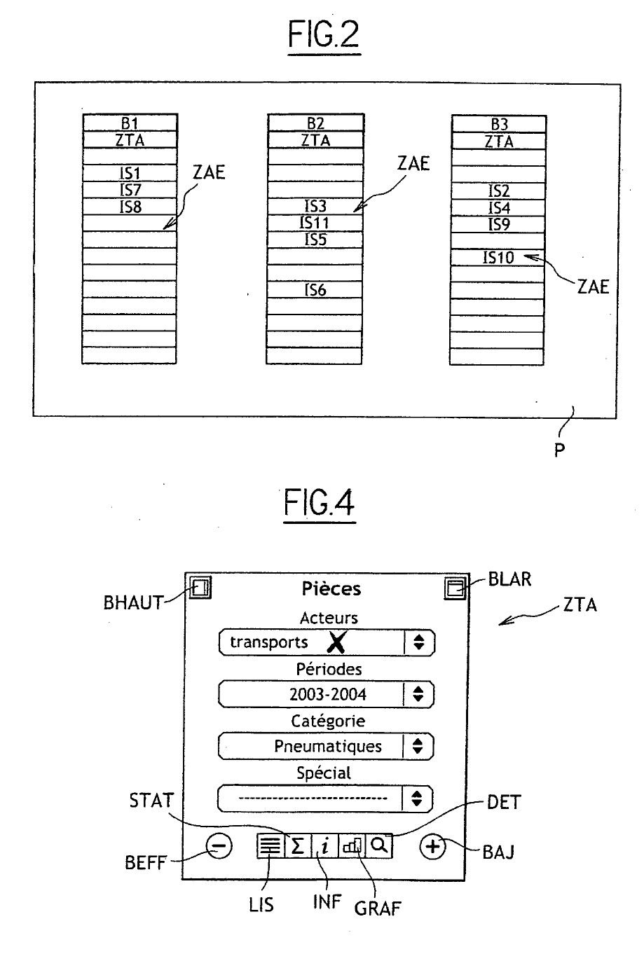

On FIG. 2, for example each data elements E is associated with an individual semantic identifier IS recorded in the memory M, which is for example a distinctive name that can be manipulated more easily and that is more explicit than its element identifier IE formed by a sequence number. Therefore, one can access to a data element E in the memory M, either by selecting its semantic identifier IS, or by selecting its data element identifier IE, whereby the selection of the semantic identifier IS automatically involving the selection of its data element identifier IE.

On FIG. 2, for example the data elements E can be attached to some modular blocks B1, B2, B3, whereby each data element is linked to only one of these modular blocks B1, B2, B3, each comprising an individual block identifier IB1, IB2, IB3, these various attachment being also recorded in the memory M.

An interface I comprising means P to present the information, for example formed by a screen, enables to display one or several modular blocks B1, B2, B3, with, in each one of these, the semantic identifiers IS of the data elements attached to these modular blocks. One or several data fields of the data element associated in the memory M can be displayed with each semantic identifier IS.

For example, on FIG. 2, the block B1 comprises the semantic identifiers IS1, IS7, IS8 of the data elements E1, E7, E8, the block B2 comprises the semantic identifiers IS3, IS5, IS6, IS11 of the data elements E3, E5, E6, E11, the block B3 comprises the semantic identifiers IS2, IS4, IS9, IS10 for the data elements E2, E4, E9, E10.

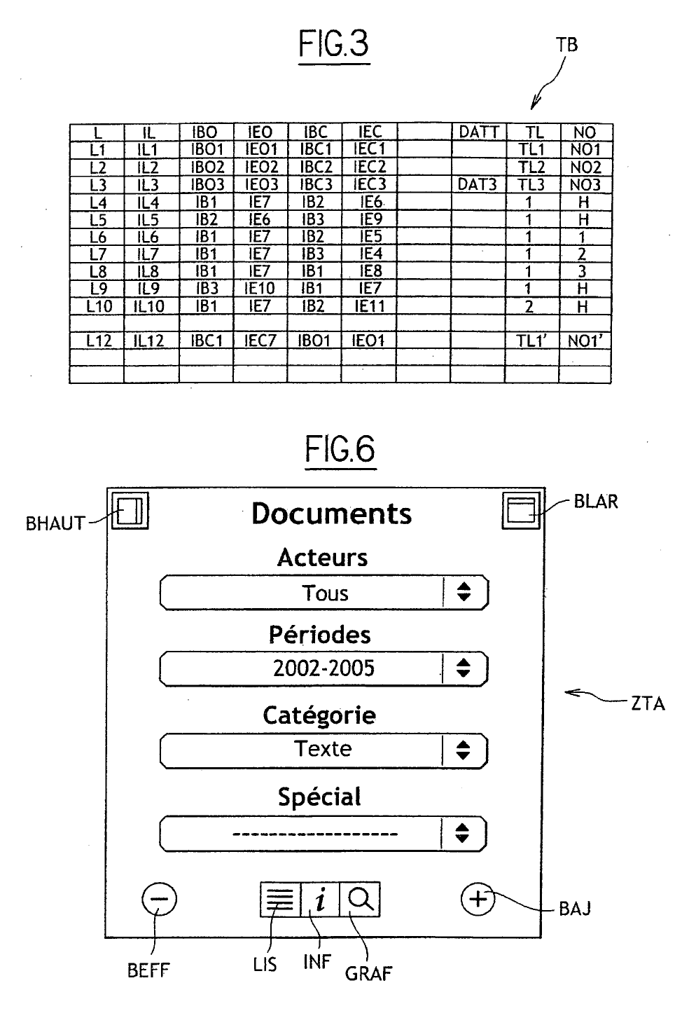

On FIG. 3, each link L is established from the identifier IEO of a source data element to the identifier IEC of a target data element different from the source data element. So each data element E can potentially be a source data element or a target data element of a link. For each respective linkL, L1, L2, L3, recorded in association in the zone Z2, the link table TB comprises:

the individual link identifier IL, IL1, IL2 IL3,

a source block identifier IBO, IBO1, IBO2, IBO3,

the source element identifier IEO, IEO1, IEO2, IEO3,

a target block identifier IBC, IBC1, IBC2, IBC3,

the target element identifier IEC, IEC1, IEC2, IEC3,

a link type TL, TL1, TL2, TL3,

a hierarchy order number NO, NO1, NO2, NO3 in the type of link,

possibly some attached data DATT specific to this link, such as the data DAT3

attached to the link L3.

The source block identifier IBO, IBO1, IBO2, IBO3 is the identifier of the block to which the source data element is attached.

The target block identifier IBC, IBC1, IBC2, IBC3 is the identifier of the block to which the target data element is attached.

A principal or guiding hierarchical order number H is attributed as a number NO to a determined link among those having the same source element identifier IEO and the same link type TL, whereas a secondary hierarchical order number, whose value is inferior to the principal hierarchical order number H, is attributed to the other links that have the same source element identifier IEO and the same type of link TL, for example with values equal to the hierarchical rank of these ones, which can be different or equal.

For example the links L are previously created by a calculator, such as for instance the means CAL, from the semantic contents of the data D of the elements E and therefore they are semantic. For that purpose, the calculator has means of semantic analysis of the data D of the elements E, in order to determine whether the data of one element are more or less close to those of another element and to provide a measure of semantic proximity. Such tools of analysis and of measure of semantic proximity are known in the state of the art, such as for example some tools of semantic weight allocation or of latent semantic indexation, such as that known as Lingway KM or those described in the universitary pieces of work such as those of Clara Yu and alii for the National Institute for Technology and Liberal Education [2002], Andrew W. Mellon Foundation. For example these tools determine some keywords from data D of each element E. An element E1 will be for example closer to an element E2 than to an element E3, if it comprises more keywords in common with this element E2 than with the element E3, which will lead to the establishment of a link from the element E1 to the E2 rather than from the element E1 to the element E3. So generally in the table TB there will be a number of links quite inferior to all of the combinations by two of the data elements. If necessary, there could exist some data elements for which no link exists, that is to say that they are the source data element of no link and the target data element of no link. There can be several types of semantic links, such as for instance the data identity links, data similarity links, data versions links, links to refer one element to another, links showing the same author for two elements, links of neighbor theme, links for elements having common quotes, membership links, ancient membership links. There can be some reciprocal links: for example the link L1 of type LT1 from the source data element IEO1 towards the target data element IEC1 has as reciprocal the link L12, which is of type TL1′ reciprocal of TL1 and which runs from the source element IEC1 to the target element IEO1.

Of course, the user can always establish or modify himself and in an arbitrary way some links between the elements, by using an appropriate interface I.

Another possibility is that the calculator automatically creates pre-emptive links, which will be presented to the user on an interface I in order to be accepted or refused thereon by activating a corresponding command, which will involve the recording in the table TB of only the pre-emptive links for which an acceptance command was activated by the user. Of course, the user will be able to activate a single command to accept all of the pre-emptive links, which will involve their recording in the table TB.

For example, it is supposed that the following links have been recorded in the table TB represented on FIG. 3:
a link L4 of the identifier IE7 of the data element E7 as source data element towards the identifier IE6 of the data element E6 as target data element, for which IL=IL4, IBO=IB1, IEO=IE7, IBC=IB2, IEC=IE6, TL=1 and NO=H,
a link L5 of the identifier IE6 of the data element E6 as source data element towards the identifier IE9 of the data element E9 as target data element, for which IL=LI5, IBO=IB2, IEO=IE6, IBC=IB3, IEC=IE9, TL=1 and NO=H,
a link L6 of the identifier IE7 of the data element E7 as source data element towards the identifier IE5 of the data element E5 as target data element, for which IL=LI6, IBO=IB1, IEO=IE7, IBC=IB2, IEC=IE5, TL=1 and NO=1,
a link L7 of the identifier IE7 of the data element E7 as data source element towards the identifier IE4 of the data element E4 as target data element, for which IL=LI7, IBO=IB1, IEO=IE7, IBC=IB3, IEC=IE4, TL=1 and NO=2,
a link L8 of the identifier IE7 of the data element E7 as source data element towards the identifier IE8 of the data element E8 as target data element, for which IL=IL8, IBO=IB1, IEO=IE7, IBC=IB1, IEC=IE8, TL=1 and NO=3,
a link L9 of the identifier IE10 of the data element E10 as source data element towards the identifier IE7 of the data element E7 as target data element, for which IL=IL9, IBO=IB3, IEO=IE7, IBC=IB1, IEC=IE7, TL=1 and NO=H,
a link L10 of the identifier IE7 of the data element E7 as source data element towards the identifier IE11 of the data element E11 as target data element, for which IL=IL11, IBO=IB1, IEO=IE7, IBC=IB2, IEC=IE11, TL=2 et NO=H.

### Data Reading

The format of the elements E and of the associated links L for example involves a reading access of the memory M according to the reading method described below.

For example the element E7 is selected by a reading command, for example by the user selecting its semantic identifier IS7 in the block B1 on the interface I. As a response to this selection received from the interface I and associated with the reading command, the means of control CAL automatically send out through the line LA1 a first request R1 to read the zone Z1, which provides as a response the data of the element E7, recorded in the zone Z1. Thereby the semantic identifier IS7 forms a means to access to the data element E7.

Moreover, when the means of control CAL have received from the interface I the selection IS7 of the element E7, associated with the reading command, the means of control CAL also send out by the line LA2 a second request R2 to interrogate the identifier IE7 of this element E7 selected as source element identifier IEO towards the link recording table TB. As a response to this second interrogating request R2 of question, the table TB detects the links L4, L6, L7, L8 and L10 which are those whose source element identifier IEO is the identifier IE7 selected in the request R2.

Then the means of control CAL execute a new access to the memory M from the target element identifiers IEC that are present in the links L4, L6, L7, L8 and L10 detected by the table, which are those associated to the source element identifier IE7, that is to say IE6, IE5, IE4, IE8 and IE11 in the above example.

For example, this access may be limited to the semantic identifiers IS5, IS5, IS4, IS8 and IS11 associated in the zone Z1 to the identifiers IE6, IE5, IE4, IE8 and IE11. In this case, the access simply implies the presentation of the semantic identifiers IS6, IS5, IS4, IS8 and IS11 on the means P of the interface I, for instance by displaying them under a different shape, for example with a different color or a mark that is different from that or those of other semantic identifiers on the screen P. The target block identifiers IBC that are present in the links L4, L6, L7, L8 and L10 detected by the table TB also control this display of the semantic identifiers IS6, IS5, IS4, IS8 and IS11 in their membership block, which is respectively the block B1 for IS8, the block B2 for IS6, IS5 and IS11, and the block B3 for IS4.

The main hierarchical order number H, present in one or several links detected by the table TB, which is in the link L4 for the type 1 of link and in the link L10 for the type 2 of link, also controls the display of the semantic identifiers of the corresponding target elements within these links, which are IS6 and IS11, under a different shape, for example with different colors or with a mark that is different from that or those of the other semantic identifiers, whereby the other semantic identifiers of the target element of the detected links, which are IS5, IS4, IS8 in this case, have the same color or the same mark for the same type of link.

When a large number of links, determined for example as being superior to a prescribed threshold, have been detected in the table TB following the second request R2 interrogating a source element identifier IEO, for example only the semantic identifiers of the target elements corresponding to some main hierarchical order numbers H in the links L4, L6, L7, L8 and L10 detected by the table TB, which are IS6 and IS11 in the above example, are presented on the means of presentation P, or only these semantic identifiers and those of the target elements corresponding to the other numbers NO of secondary hierarchy that are the highest within the limits of the prescribed threshold are presented on the means of presentation P, which are IS6, IS11, and IS8 if this threshold is equal to 3, IS4 and IS5 being therefore not presented.

When the semantic identifiers IS6, IS5, IS4, IS8 and IS11 of the target elements of the links detected in the table TB have been presented on the means P, the user can activate a command of individual reading of one or several of these ones, which will provoke the reading of the data D6, D5, D4, D8 or D11 of one of the corresponding elements in the zone Z1 and their presentation on the means P. Therefore the semantic identifier IS7 forms a means to access to the other elements E6, E5, E4, E8, E11 having a link with the element E7 having this semantic identifier IS7.

### Data Search

Another application of the format of the elements E and of the associated links L is the method of data search as described below.

The element E7 is for example selected by a search command, for example by the user selecting its semantic identifier IS7 in the block B1 of the interface I.

When the means of control CAL have received from the interface I the selection IS7 of the element E7, associated with the search command, the means of control CAL send out by the line LA2 a request R2 interrogating the identifier IE7 of this element E7 selected as source element identifier IEO towards the link recording table TB. As a response to this interrogation request R2, the table TB then detects thanks to the means CAL the links L4, L6, L7, L8 and L10 which are those having as source element identifier IEO the identifier IE7 selected in the request R2.

Then the means of control CAL execute a new access to the memory M from the target element identifiers IEC which are present in the links L4, L6, L7, L8 and L10 detected by the table, which are those associated with the source element identifier IE7, which are IE6, IE5, IE4, IE8, IE11 in the above example.

This access is limited to the semantic identifiers IS6, IS4, IS4, IS8 and IS11 associated in the zone Z1 with the identifiers IE6, IE5, IE4, IE8 and IE11, and involves their distinctive presentation on the means P, as it has been described above for the reading process, and their selection.

When the semantic identifiers IS6, IS5, IS4, IS8 and IS11 of the target elements of the links detected in the table TB have been presented on the means P, the user can activate an individual reading command for one or several of these ones which will provoke the reading of the data D6, D5, D4, D8 or D11 of one of the corresponding elements in the zone Z1 and their presentation on the means P.

The data search can also be pursued from the semantic identifiers IS6, IS5, IS4, IS8 and IS11 of the target elements of the links that have been detected in the table TB.

For example, to pursue the search, the user commands on the interface I a next search level referring to the previous search level that has provided the semantic identifiers IS6, IS5, IS4, IS8 and IS11 from the semantic identifier IS7 initially selected by the user.

During this next search level, the means of control CAL executes the previous process of interrogation of the table TB in order to detect the target element identifiers IEC associated in links L with the source element identifiers IEO formed by the target element identifiers IEC presents in the links detected by the previous search level, which are in the above example the target element identifiers IEC associated with the identifiers IEO made of the identifiers IEC=IE6, IE5, IE4, IE8, IE11 previously obtained in the links of respective identifiers IL4, LI6, LI7, L18, IL10.

Then in this example, one obtains for these source element identifiers IEO=IE6, IE5, IE4, IE8, IE11, respectively the target element identifier IEC=IE9 (by the link L5), which will be presented on the means P, under a different shape, for example with a color or a mark specific to this next search level and different from those of the other search levels, so that the corresponding data element E9 could be read through a reading command activated by the user. In this example, a new search level on IE9 would bring no result, as it is not the identifier IEO of a source element in table TB. Of course, one or several new search levels could be applied as the previous levels in the case where each following level brings a new element identifier IE, different from those previously obtained.

As a variant, a prescribed number of search levels is fixed in advance and these search levels are successively and automatically executed by the means of control CAL.

Each modular block B1, B2, B3 comprises for example a zone ZDT of selection by the user of display type, in order to select the data fields that will be displayed or not displayed with the semantic identifiers IS attached to this block in a part ZAE of display of elements E of the block B, whereby these data fields are predetermined for each element E from the data D that it contains. Therefore, each modular block B1, B2, B3 comprises a distinct and predefined structure of display, which gets applied to every data element attached to this block.

Each modular block B1, B2, B3 can be associated with its own link recording table TB, exclusively comprising the links having as source element a data element E attached to this block, that is to say in the previous example, for the block B1 a table TB 1 containing the links L4, L6, L7, L8 and L10, for the block B2 a table TB2 containing the link L5 and for the block B3 a table TB3 containing the link L9.

### Document Printing

Another application of the format associating the elements E to the links L is a method of automatic printing of a document calculated from elements and links.

We assume that to every modular block B1, B2, B3 are linked the data elements of a same semantic category specific to this block and different from one block to another. So there is for example a block B1 for the semantic category <<person>>, a block B2 for the semantic category <<flights>>, a block B3 for the semantic category <<locations>>.

Previously a predetermined body of text is recorded for one or several ordered combinations of blocks, such as for example:
<<X took the flight Y leading to Z>> for the ordered combination (B1, B2, B3)

where X, Y, Z are semantic identifiers IS of respectively B1, B2, B3.

When for example the link L4 then the link L5 are selected, the means of control CAL will create the document comprising the text: IS7 <<took the flight>> IS6 <<leading to>> IS9, since in the above example, the link L4 connects the source element identifier IE7, attached to the block B1, to the target element identifier IE6, attached to the block B2, and since the link L5 connects this source element identifier IE6, attached to the block B2, to the target element identifier IE9, attached to the block B3. The links L4 then L5 form a sequence of links from E7 towards E9 passing by E6.

Thanks to a corresponding command of the user on the interface P, the means CAL will provoke the automatic printing of the document previously created on a printer IMP connected to the means CAL.

### Data Transmission

The selection of an element E, for example of the element E7, and the selection by links of the associated target elements, E6, E5, E4, E8 and E11 and/or the links L4, L6, L7, L8, L10 having as source element this selected element E7, can be transmitted to an external output S of the machine MLOC of the user, in order to be transported towards a remote machine MDIST through a telecommunication network RES and to update the memory MD of the remote machine MDIST with these elements and/or links. If necessary, the update of a data element of the remote memory MD automatically involves its communication to the local machine MLOC, the search in the local memory M of the links that have this selected element as source element, the transmission of the target elements and/or associated links from the local machine MLOC to the remote machine MDIST and the corresponding update of a remote link table TBD in the remote memory RM with these target elements and/or associated links.

### FIRST EXAMPLE OF EMBODIMENT

A first example of embodiment of the invention refers to the logistics of a transporting vehicles fleet, within a company specialized in carriage, vehicle rental, or within the transportation/logistics department of a large company, and more precisely the management of tyres. By logistics it is meant the monitoring of the allocation, the activity, the operating state of the vehicles and of their components, the help for making decision about them, in particular by making forecasts

The system described above uses the various formats and methods described above and enables the user to obtain two types of technological results:

time saved in the information research,

the production of supported certificate reports, in particular of traceability.

In the present case, the different data elements E may concern some individuals playing the part of drivers or passengers, some time periods such as the week or the month, some tractor vehicles or semi-trailers, some tyres individually identified according to the international regulation UNECE R56 and R54, and at last some documents such as route papers (written accounts of the vehicle rides), assembly/disassembly reports, review statements and other technical documents.

These various elements E are all individually identified by a unique sequential number IE, and for example a semantic identifier IS is also associated to each one of them, for example <<Guillaume>>, <<February 2004>>, <<Red Iveco Tractor 2034 ZQ 35>, <<Pneum. 315/60 R 22.5−DOT F3 3H BBH×2200 1>>, <<Route Paper N^{o} 14935>>.

The elements E can be associated by pairs by recorded links L of several types LT, one link of type <<team>> (equipment link) indicating for example that a determined tyre is assembled on a determined vehicle.

A sorting number (NO), that can be modified by the user, is automatically assigned to the target elements for a same type of links, emanating from a specific source element. For example the tyres equipping a vehicle, are automatically ranked according to a geometric order (front, back, left, right), that order can be modified by the user in order to rank them according to the vehicle mileage, wear, brand or any other criterion.

Some data DATT can be attached if necessary to a link L, in the form of a XML file, like in the present case of the equipment link, the indication <<from the 12/02/2004 to the 19/06/2004 in the position Front Right unflipped on the rim>>.

To each link corresponds a reciprocal link with the same attached data, being in the above example, a link of type <<is equipped with>>.

The different elements are aggregated inside blocks, in this case there are five of these, whose block identifier is:
Actors,
Periods,
Vehicles,
Pieces,
Documents,
   in order to comprise each of the elements E of the type corresponding to their block identifier.

The below table takes inventory of the different links, their source block, their types, including their real or virtual nature, their target blocks, their sorting number for each source element, and the kind of the attached data:

TABLE TB

| Source Element | | | Target Element | Attached |
|---|---|---|---|---|
| Block | Link Type | Sorting Order | Block | Data |
| Docts- | <<Concerns the | Chronological | Parts | Before/after |
| Assembling | assembling of>> | according to the | | Location |
| Report | | operation | | |
| | <<Concerns the | Chronological | Vehicle | |
| | equipment of>> | according to the | | |
| | | operation | | |
| | <<Performed | Chronological | Period | |
| | during>> | | | |
| | <<Executed by>> | Alphabetical | Actors | |
| | <<Associated to>> | Chronological | Documents | |
| Reciprocal links: | | | | |
| Parts | <<Assembled | Chronological | Docts- | Before/after |
| | according to>> | according to the | Assembling | Location |
| | | operation | Report | |
| Vehicle | <<Equipped | Chronological | Docts- | |
| | according to>> | according to the | Assembling | |
| | | operation | Report | |
| Period | <<Includes | Chronological | Docts- | |
| | assembling | | Assembling | |
| | according to>> | | Report | |
| Actors | <<Performed the | Alphabetical | Docts- | |
| | assembling | | Assembling | |
| | according to>> | | Report | |
| Documents | <<Associated | Chronological | Docts- | |
| | back to>> | | Assembling | |
| | | | Report | |
| Docts - Worksheet | “has used” - | Location on vehicle | Parts | Positions |
| | virtual | | | |
| | “concerns | Chronological | Vehicle | Mileage |
| | transport by” | according to the | | |
| | | operation | | |
| | “performed | Chronological | Period | Journey |
| | during” | | | Conditions |
| | “performed by | Chronological | Actors | Schedule Role |
| | driver” | according to the | | |
| | | operation | | |
| Reciprocal links: | (Similar to | | | |
| | above): | | | |
| Docts - Check-out | (Similar to | | | |
| report | above) | | | |
| Parts - Pneumatics | <<Has been used | Chronological | Parts | Beginning, |
| | with>> - virtual | | | end, location |
| | <<Equips or has | Chronological | Vehicule | Beginning, |
| | equipped>> | | | end, location |
| | <<Has been used | Chronological | Period | |
| | during>> - virtual | | | |
| | <<Has been used | Chronological | Actors | Mileage, |
| | by>> - virtual | Modifiable | | Wear-out |
| Reciprocal links: | (Similar to | | | |
| | above) | | | |
| Vehicles - | <<towed>> | Chronological | Vehicules - | Beginning, |
| Tractors | | Modifiable | Tractor trailer | end |
| | <<Has been | Chronological | Periods | Actors |
| | driven during>> - | | | |
| | Virtual | | | |
| | <<Has been | Chronological | Actors | Mileage |
| | driven by>> | | | |
| Reciprocal links: | (Similar to | | | |
| | above): | | | |
| Periods - Week | <<Belongs to>> - | Chronological | Periods - Month | Beginning, |
| | Virtual | | | end |
| | <<Concerned>> - | Alphabetical | Actors | |
| | Virtual | Modifiable | | |
| Reciprocal links: | Similar to | | | |
| | above) | | | |
| Actors | <<Came along | Alphabetical | Actors | Beginning, |
| | with>> - Virtual | Modifiable | | end, n°RM |
| Reciprocal links: | (Similar to | | | |
| | above) | | | |

For each of the blocks, the table TB centralizes the recording of the direct or reciprocal links, concerning this block, and it comprises, recorded in association with each link identifier IL, an identifier IBO of the attachment block of the source element of this link and an identifier IBC of the attachment block of the target element of this link, which are, under a preferential shape, the fields:
Sequence N^{o} of the link (IL),
Source block of the link (IBO),
Sequence N^{o} of the source element (IEO),
Target block of the link (IBC),
Sequence N^{o} of the target element (IBC),
Link Type (LT),
Order N^{o} of the link in the type and in the beam of links that have the same source (NO),
Data (X) attached to the link (sequential referring to a common table).

The links of a real type are created as permanent informatic recordings in the table TB, which can be modified afterwards, for example in order to modify the period of allocation of a tractor to a trailer. On the contrary, the links said to be virtual can only be created on request, if a question of the user needs it, by automatic calculation from the other links or by analysis of the contents. Generally they are recorded during a predetermined life length, then they are deleted as recordings in the table TB. For example, the fact that a specific tyre has been used by a determined driver will be recorded as a link only after the trigger of an annual survey of the relationship driving/care/wear, and this temporary link will be deleted in the table TB after a few days in order not to load the base M with redundant information whose fastness of access is no longer useful. In a similar way, elements E of virtual type can be defined without being immediately created as a recording. For example, a transition towards one management per day even per hour or minute, will bring about the creation of 7 period elements for each considered week, 168 elements E in the case of hours and 10080 in the case of minutes. These elements E will only have the possibility of being created when a particular question gets raised, for example for a precise analysis of the driving times on a short period.

### Zone of Display Type Selection ZTA (FIG. 4)

Each one of the blocks B lets appear a Zone of display type selection (ZTA) which, in a case of embodiment, is present on the upper part of the block with an identical structure for every blocks. The display type selected in the zone ZTA leads either to the display of only the elements selected by the display type command activated by not displaying the other elements of the block, or to the display of the elements selected by the display type command activated under a different shape (distinctive presentation) of the other elements of the block, as it was described on what precedes.

The zone ZTA is for example totally displayed by a double-click on the title or identifier of the block B, and it contains, for each block B:
Four unrolling menus of selection of type of display controls, entitled Actors, Periods, Categories and Special:
   Menu Actors (answers the question: Who?) to display the elements E of the block B, answering to the semantic identifier IS=one or several particular actors (Transports X on FIG. 4). The Actors Menu comprises the commands: All, recent, A-Z, Search Company, Search Name, Group, Modify. Therefore, except for the command All, this menu of commands will only give the elements E displayed in the block B if they have a link with the actors selected by this command.
   Menu Period (answers the question: When?) to display the elements E of the block B, answering to the semantic identifier IS=one or several particular periods (2003-2004 on FIG. 4). The Period menu comprises the commands: All, Today, Yesterday, The day before yesterday, Present week, Last week, The week before last week, Present month . . . , Trimester, Year, Date to date, Modify. Therefore, except for the command All, this menu of commands will only give the elements E displayed in the block B if they have a link with the periods selected by this command.
   Menu Category (answers the question: what?), to display the elements E of the block B, answering to the semantic identifier IS=one or several particular element categories (<<pneumatics>> on FIG. 4). The Category menu comprises:
      the general commands: All, Latest, A-Z, Search Category, Search Group, Modify,
      especially for the block Pieces: the commands of pieces categories Tyres, Engine, Air filter, Radiator, Drier, Spark Plugs, Direction, Heating, Cabin, General Condition, Repair to be made,
      especially for the block Documents, the commands of document categories: Transport Papers, Route Papers, Assembly Reports, Review Statement, Sanitization Statement, Bills, Orders.
   Special Menu, which aggregates the specific diverse and scalable actions:
      Prerecorded display (List), which activates a display previously recorded by the two commands below,
      Complex Search,
      To save the display of the present elements,
      To limit the display to the selection of present elements in the block,
      To display the virtual links of the elements, for example of level 2,
      To choose as Director Block,
      Witness color (Mark, Modify, Display, Erase color),
      To print the file of the selection (pre-written file recorded in association with a predetermined printing format such as for example Word or pdf, as one chooses),
      To store the prerecorded report,
      the command <<take account of the attached data>> which allows for example to limit the display to periods that the elements of a same block have in common,
      To export,
      To modify (the Menu Special, the Block settings . . . ),
Two buttons of sizing of the ZTA zone of Block Display, in width (BLAR) and in height (BHAUT),
Two buttons of elements addition (BAJ) and erasing (BEFF) in the block B. The addition button creates a new element E in the block B. The erasing button deletes the element E selected in the block B (with confirmation warning).
Five buttons of presentation of the elements E of the block in List (LIS), Detail (DET), Information (INF), Statistics (STAT), Graphs (GRAF).
   The button LIS presents the elements E as a list (option by default).
   The button DET displays a detailed view of the single element selected.
   The button STAT presents a figured analysis of the displayed elements E.
   The button GRAF presents the elements E as charts (histogram, circle, S curve . . . ).

These different menus and buttons can be inactivated, darkened or masked by preferences settings for each user, for each board and for each block.

### Access to the Elements Detail by Action or by Link

It is possible to access to the details of each element E of a block B, either by link, or by a simple or double click on this element, or by the button <<detail>> of the zone ZDT. For example, one can view the scanned image of a route paper that was mainly handwritten (rides, stages, lengths, mileage) or, in this way one can visualize the detailed coordinates of an Actor. In the case where the element, resulting from a selection by menu or links, is unique, one can choose, by a preferences adjustment, to display it automatically in detail and not only under a summed up version.

### Recording, Interrogation, Modifications

It is possible, thanks to commands of choice in a list or by sliding and dropping, to create a link L connecting an element E of a block B1 to a multiplicity of elements E of several blocks B, possibly including the same block B1, to assign to the link L a type TL, and also to modify this link in terms of type TL, of rank NO in the type TL, of target IEC, or to destroy this link, this method having the possibility of being qualified of generalized multi-parenting for data, documents, folders, periods and more data elements categories.

Pre-Emptive links

During the display of the information or metadata concerning an element, activated for example by the button <<Info>> or the button of validation of creation/modification, some links called pre-emptive links are automatically suggested by application of existing tools of semantic proximity measurement applied to the data and metadata of the different elements. The creation of the link is activated by the simple acceptance of the user. In the present case, this concerns in particular the Actor of category Driver, directly associated with a Route Paper, or the transportation letters associated with this same Route Paper, or the vehicle sanitization reports concerning it.

### Automatic Links

In certain cases, the links are automatically created, instead of just being suggested, possibly after the approval previously and globally given by the user for a set of data elements. For example, while typing an assembly report, the links are automatically created with the appropriate elements of the blocks Pieces, Vehicles, Periods and Actors.

### Virtual Links

For some processing efficiency reasons, some elements E and links L are virtually created, and are only recorded during a predetermined time period.

### Access by Multiple Links

It is possible to search some information by specifying, for example by a simple click, one or several source elements from a same block, and by activating the distinctive display of the target data elements called of level 1, which are linked to it by the different links of the different types.

In the same way, it is possible to obtain the display of target data elements called of level 2, that is to say linked to one or several target elements of level 1 considered as source elements and specially designated, this process also including the display of target elements of level 3, 4 and superior.

### Logical Operators

An information research known as complex is activated by a command of the special menu. It leads to the distinctive display of the target elements of level 1 or superior, by application of logical operators to the propagation of links.

For example, the choice <<logical union>>, which is the choice by default, for the links concerning the elements E of a same block B leads to the simultaneous display of the target elements connected by link(s) L to any one of several source elements: for example, target documents of January or February 2004 as source period.

Likewise, the choice <<logical intersection>>, for the links concerning the elements E selected from a same block B leads to displaying only the target elements connected by link(s) L to each and every one of these source elements selected: for example, tyres having equipped two different vehicles as source elements.

Furthermore, the choice <<logical intersection>> which is the choice by default, for the links L concerning the elements E selected from different blocks B, leads to displaying exclusively the target elements connected by link(s) L to each and every one of these source elements selected: for example, target vehicles simultaneously linked to a determined driver and to the period July 2004 as source elements.

### Transmission

When it is necessary to transmit structured data to another user, for example within the framework of a vehicle assignment where a complete and consistent history for this vehicle has to be transmitted, the command Export of the Menu Special is activated. It activates the transmission by electronic communication according to common protocols from an output S of the user's machine on FIG. 1, of the data structure including some source data elements (that of the vehicle to be sold in the above example) and the data, documents, metadata and associated links respectively associated to these source elements, and also permits the reception by a machine of the other receiver user, Client in the informatics sense or Server, of this data structure, and the integration of this complete data structure into the whole data elements of the receiver user's machine, expressed by the links and metadata. According to the user's choice, the associated target elements can also be transmitted.

### Synchronization

For some security or sharing reasons, the set of data elements of a user, or a subset, communicates through an informatics network with another set or subset of data elements, residing on a remote server computer. These sets remain identical throughout the time, whereby this operation known as synchronisation is occasionally executed when an informatic connexion between two machines is available.

### Reports Printing

With each link type TL and for each block B is associated a text and syntactical form of sentence composition, possibly multilingual, meant to build some printable textual explanations for each link or group of links between data elements, the links being in this case called semantic links. The command <<Print the selection folder>> in the menu <<Special>> activates the printing of a report comprising the list of elements and links displayed as results of the selection, in order of the semantic hierarchical links, joined with some pertinent explanations, according to the example given below.

In the daily functioning, the system is meant to be operationally used for the vehicles chartering, the emission and recording of the Road Papers and of the Transportation Papers, forecast, decision, monitoring of the maintenance execution. It is also used in order to make sure of the conditions of wear or of functioning of the different pieces including the tyres, with generation of alerts, and calculation of inventories that are valorized and conciliated with the forecasts, as well as calculations of depreciation, of distribution on several fiscal years of representative costs of the wear of the pieces pool.

The precision and time savings are daily and significant mainly thanks to the semi-automatic search that is directed and guided. These are described below in a particular case of crisis where demands can happen to be particularly constraining.

At the time of sanitary crisis, for example of epidemic or of epizootic, as those that happened in 1996 and 2000 in the cattle industry and breeders (BSE, foot-and-mouth disease), or several times in the poultry industry and breeders (Dutch and Italian bird flu, SARS in Asia), the demands for traceability instantaneously become high-pitched. It concerns the merchandise traffic as well as the traffic of vehicles and of any contamination spreader, their travel, inspection, disinfection.

The tyres constitute one of these spreaders, which is particularly controlled and potentially contamination spreader, especially since it can switch vehicles and geographically multiply the risks.

The logistics management system described below permits, in this situation, to obtain as a technical result a time saving in information research, as it is explained thanks to the example 1 described below.

It is possible to immediately visualize a tyre and its history thanks to its multi-parenting by the link <<team>> that associates it with the different vehicles, with, associated by link, the attached data of period and of position on the vehicle, the road maps associated and therefore, its complete travel (with mileage on each position).

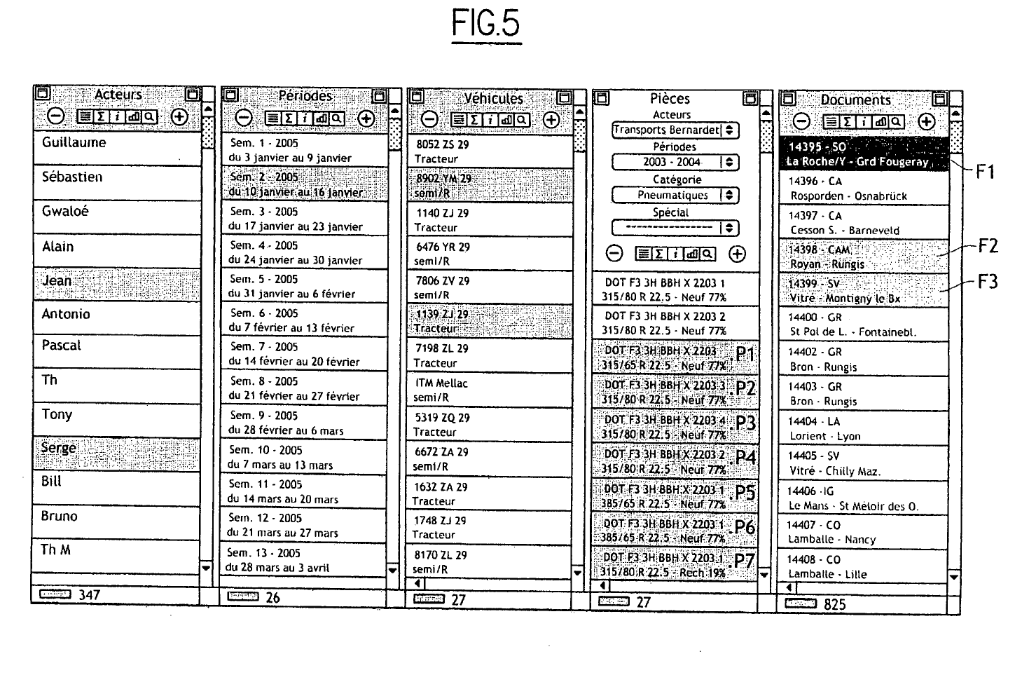

### Example 1 of the Successive Steps Implemented on FIG. 5:

1. Selection by click in the Block <<Documents>> of a road map F1 concerning a suspicious zone,

2. Choice, in the menu Special of the zone ZTA of the block Documents, of the control <<Display the virtual links>>, in order to activate the display, in the block <<Pieces>>, of the target elements <<Pieces>> P1, P2, P3, P4, P5, P6, P7 with which the source element <<selected Road map>> F1 possesses some recorded virtual links of the type <<used>>.

3. Display command, in the block <<Pieces>>, of the elements of the category <<pneumatics>> P1, P2, P3, P4, P5, P6, P7, by the command of category <<pneumatics>> or limitation of the display to these pneumatics that are the only ones concerned, by the button BHAUT of the zone ZTA of the block Pieces.

4. Reduction of the display just to the blocks that are considered as interesting, by the buttons BLAR of the blocks Actors, Periods, and Vehicles.

5. Choice, in the menu Special of the zone ZTA of the block <<Pieces>>, in order to activate the display in the block <<Documents>>, of the target elements, with which the selected source elements <<pneumatics>> P1, P2, P3, P4, P5, P6, P7 possess some reciprocal recorded virtual links of the type <<has been used by>>, which leads to the Road Maps F1, F2, F3 having used these pneumatics in the block <<Documents.>>

6. Display command, in the block <<Documents>>, of the elements of the category <<road map>> F1, F2, F3, by the command of corresponding category or by reduction of the display to these only concerned elements by the button BHAUT of the zone ZTA of the Block Pieces.

7. Additional reduction of the display of the block <<Documents>> to the only road maps F2, F3 posterior to the initial road map F1 by the menu Periods of the zone ZTA of the block <<Documents>>.

Overall, these seven actions represent a delay of response that is less than a minute and supply, as a board displayed on the screen, through road maps, the essential researched information as a response to the question: <(What has been the travel of the tyres that have passed through a given geographic area during a given period?>>.

These seven actions can be stocked as a prerecorded display, by the command <<record the display of the current elements>> of the menu Special of the block Documents, for an ulterior use. It is possible to answer as quickly to the similar questions that refer to the operations of sanitization, assembly and disassembly, or that refer to the identification and localization of the interested vehicles, drivers and passengers.

This fastness of reaction is reached without any programming for the user, by a user who is not a computer specialist. It issues from a visual and semi-automatic implementation of the generalized multi-parenting of the various elements.

Moreover, the logistical management system described below allows to obtain as a technical result the production of supported justifying reports, in particular of traceability, as it is explained thanks to the example 2 below.

From the situation that was previously described referring to FIG. 5, it is possible to activate the printing of a document or of a justifying report that only exposes the elements F1, F2, F3, P1, P2, P3, P4, P5, P6, P7 and the selected and displayed links. This report utilizes the semantic character of the links and of the elements, the order of the links originally from each element of each type, the elements data, the possible data attached to the links, the predetermined sets of texts associated with each type of links.

### Example 2 of the Successive Steps to Print a Justificative Report of the Elements Displayed on FIG. 5:

1. Choice, in the Menu special of the zone ZTA of the Block <<Document>> of the command <<Print the folder of the selection>>.

2. Choice of presentation options, including for example the destination computer folder and/or printed paper, the numbering or the indentations.

3. The following text is printed on the printer P and/or recorded in a folder, the words inside the brackets being some explanations that do not form a part of this text:

(Title:) Traceability Report concerning Road Map N^{o} 14492

Date of Publishing: . . . .

(Text:)

Road Map 14395 (F1)
has the summarized data AAA
is described in detail in the annex 1
has used the pneumatics of the following references:
   1 tyre of Brand M N^{o}BBB (P1)
   1 tyre of Brand M N^{o}CCC (P2)
   1 tyre of Brand M N^{o}DDD (P3)
   1 tyre of Brand M N^{o}EEE (P4)
   1 tyre of Brand M N^{o}FFF (P5)
   1 tyre of Brand M N^{o}GGG (P6)
   1 tyre of Brand M N^{o}HHH (P7)
   The pneumatic of Brand M N^{o}BBB
      has the summarized data BB
      is described in detail in the annex 2
      has been used by the road maps, posterior to
14395 (F1), whose references are the following:
   14398 (F2)
   14399 (F3)
   Road Map FDR 14398 (F2)
      has the summarized data III
      is described in detail in the
      annex 3
   Road Map FDR 14399 (F3)
      has the summarized data JJJ
      is described in detail in the
      annex 4
   The pneumatic of Brand M N^{o}CCC (P2)
      has the summarized data CC
      is described in detail in the annex 5 has been used by the road maps, posterior to
14395 (F1), whose references are the following:
   FDR 14399 (F3)

(Etc. . . . )

(End of Text)

The triggering and execution of this printing lasts less than five minutes. The user can produce a detailed, supported report without any ambiguity, comprising in a fluent written language, the essential requested information as a response to the question: <<What has been the travel of the pneumatics that have passed through a given geographic area during a given period?>>

The report obtained by these three actions of example 2 and the previous seven actions of example 1 can be stored as a prerecorded report thanks to the command <<Store the prerecorded report>> of the menu Special of the Block Documents, for a ulterior use. It is possible to answer as accurately to the similar questions referring to the sanitization operations, or to the identification and

localization of the interested vehicles, drivers and passengers.

This quality of edition is reached without any programming, by a user who is not a computer specialist. It issues from a visual and semi-automatic implementation of the semantic and hierarchical links defined between the various elements.

### SECOND EMBODIMENT EXAMPLE

The second embodiment example refers to the management of the data and documents of an individual within the framework of his private and/or professional activity. By data management we mean its typing, filing, consultation, modification, storage in a scalable way.

The data management system described below uses the different described formats and methods and allows to obtain the technical result of a time saving in the information research.

In the present case, the different data elements E may concern some physical or moral person, some time periods like the week or month, some filing folders, and at last some text documents, electronic mails, pictures, webpage, audio, video, of various types.

This second embodiment example possesses a data structure that is similar to that of the first embodiment example described above, only the specificities and differences of the second embodiment example being described below.

The different elements are grouped together in some blocks B, in the present case there are four of those, whose block identifier is:

Actors,

Periods,

Folders,

Documents,

to contain each one of the elements E of the type corresponding to their block identifier.

The elements can be associated by pairs thanks to several types of recorded links, one link of the type <<belongs to the folder>> (parenting link) indicating for example that a specific document is filed in a determined folder.

The target elements by a same type of link, emanating from a specific source element, are assigned a sorting number by default, which can be modified by the user.

For each link L, the target element of identifier IEC is called ascending element of the source element and the source element of identifier IEO is called descendant element of the target element. An ascending element of another element can belong to the same block as this other descendant element.

For example, the ascending folders of a given folder, are classified by default in a chronological order of links creation, this order can be modified by the user in order to classify it in alphabetical order, significance order or any other criterion.

If necessary, some data can be attached to a link, in the form of an XML file. For example in the case of the link of type <<resembling to>> between some documents, the data attached to this link comprise for example the list of the retained keywords and the value of the index of semantic proximity calculated by a specialized engine.

A reciprocal link with the same attached data corresponds to each link, which is in the above example, a link of the type <<is recognized as resembling to>>.

The board below takes inventory of the different links, their source block, their types, including their real or virtual nature, their target blocks, their sorting order for each source element, and the nature of the attached data:

| Source Element | | | Target Element | Attached |
|---|---|---|---|---|
| Block | Link Type | Sorting Order | Block | Data |
| Documents | <<Resembles>> | Alphabetical | Documents | Keywords + |
| | | | | Proximity Index |
| | | | | Value |
| | <<Belongs to>> | Chronological | Folders | |
| | | Modifiable | | |
| | <<Has got its date | Chronological | Periods | Kind of date |
| | in>> | | | |
| | <<concerns>> | Alphabetical | Actors | Role(s) |
| Reciprocal Links: | | | | |
| Documents | <<is known as | Alphabetical | Documents | Keywords + |
| | resembling | | | Proximity Index |
| | from>> | | | Value |
| Folders | <<contains>> | Chronological | Documents | |
| | | Modifiable | | |
| Periods | <<contains the | Chronological | Documents | Idem |
| | date of>> | | | |
| Actors | <<is concerned | Alphabetical | Documents | Role(s) |
| | by>> | | | |
| Folders | <<is included in>> | Chronological | Folders | |
| | | Modifiable | | |
| | <<Contains some | Chronological | Periods | |
| | documents | | | |
| | from>> - Virtual | | | |
| | <<contains some | Alphabetical | Actors | |
| | documents that | | | |
| | concern>> - | | | |
| | Virtual | | | |
| Reciprocal | (similar to | | | |
| Links: | above) | | | |
| Periods | <<Has got its date | Chronological | Periods | |
| | in>> | | | |
| | <<Contains the | Alphabetical | Actors | |
| | date of a | | | |
| | document | | | |
| | concerning>> - | | | |
| | Virtual | | | |
| Reciprocal | (similar to | | | |
| Links: | above) | | | |
| Actors | <<is related to>> | Alphabetical | Actors | Beginning - end |
| | <<is concerned | Alphabetical | Actors | Beginning - end |
| | by a document | | | |
| | also | | | |
| | concerning>> - | | | |
| | Virtual | | | |
| Reciprocal | (similar to | | | |
| Links: | above) | | | |

The links of type real are recorded as permanent computer recordings, which can be modified afterwards, for example in order to modify the author of a document, or at the moment of the activation of a specific question, for example within the framework of the hour per hour monitoring of the making of a magazine, with some successive versions of articles, titles, and page setting guide.

Selection zone ZTA (FIG. 6)

The ZTA zone contains for each block B:
Four unrolling menus of selection titled Actors, Periods, Categories and Special
   The menu Actors (<<All>> on FIG. 6), the menu Period (<<2002-2005>> on FIG. 6) and the menu Special described above for the first embodiment example,
   The menu Categories (category <<text>> on FIG. 6), which comprises in addition the general controls indicated above for the first embodiment example:
      especially for the block Document, the commands of display of document properties: Document format, Size of document, Type of document
   Both buttons BLAR and BHAUT, including the button BHAUT which limits the display of the block to the elements that are ascending and descendant of the element selected in the block.

### Links

It is possible, thanks to some choice commands within a list or by drag and drop, to create a link connecting a Folder to multiple Folders, connecting a Document to multiple Folders, and more generally connecting an element (Document, Folder, Actor, Period) to multiple elements.

Pre-emptive links notably concern the folders suggested by the system in order to be associated with a document, by the link <<contains>>.

Automatic links concern for instance the case of the links of resemblance between documents.

Within the framework of a daily use, the system is meant for the construction of a personal perennial knowledge base. We can observe the specific case of the work of a journalist whose deadlines can happen to be particularly restrictive.

### Familial Navigation

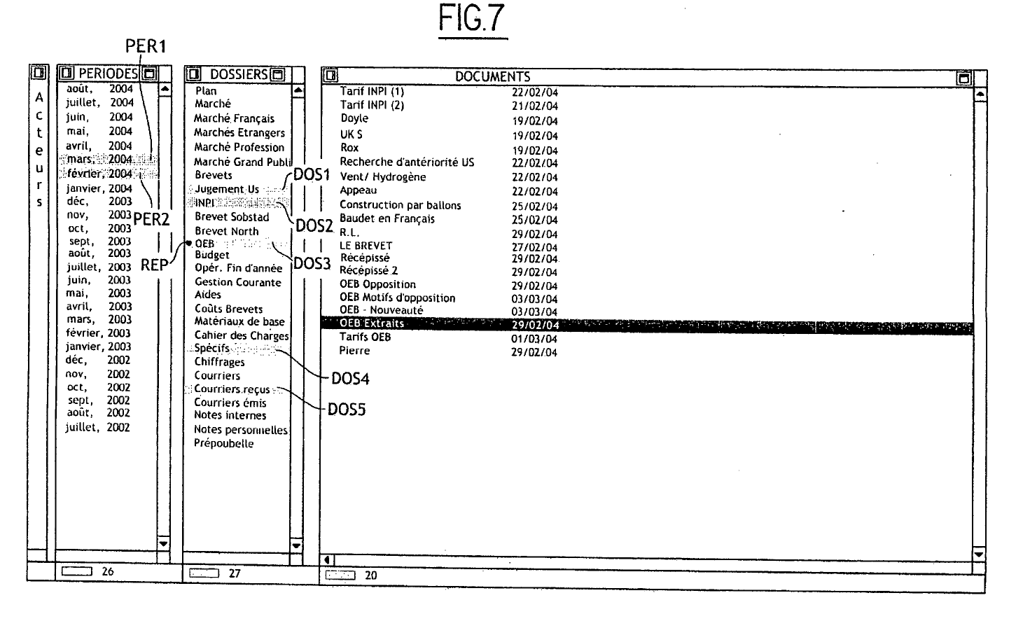

To search some elements, documents, folders, periods or actors, within some significant data volumes, it is possible to execute a navigation from one point to another, without using the keyboard. This navigation is represented by the fact that, while clicking on an element, for example the element DOC1 from the block <<Documents>> on FIG. 7, its ascending elements, for example in the block <<Folders>>, the folders DOS1, DOS2, DOS3, DOS4, DOS5 targets of DOC1 by the link <<belongs to>> are highlighted by a distinctive display, which can be a special and parameterizable color, for example blue. A mark REP can be placed on the folder DOS3 to indicate that it is the linked element that has the highest hierarchy number H in priority among DOS1, DOS2, DOS3, DOS4, DOS5, whereas for example DOS1, DOS2, DOS4, DOS5 have the same hierarchy number inferior to that of DOS3. The same thing happens to its descendant elements, with another distinctive display, for example yellow. For the sake of clarity, the button BHAUT of the zone ZTA allows to limit or not to limit the display to these only ascending elements, the selected element(s), and the descendants. Because of the similarity that exists between the multiple ascendings and descendants and an actual living family, this navigation is called familial navigation. Therefore, while clicking on a displayed ascending or descendant that instantaneously becomes a new source element, it is possible to execute a familial navigation in a strictly similar way, inside each one of the blocks and from one block to another. This concerns the navigation among a large number of documents, as well as among the folders, throughout the time thanks to the periods, and in the society thanks to the actors. A selection of the folder DOS2 as source element provides through the link <<contains some documents of>> the target periods PER1 and PER2 of the block <<periods>>.

### Modularity

As the different blocks operate identically, they are preferentially made from a singular computer code text, that is simply configured to be adapted to each particular block situation (Actors, Periods, Folders, Documents or other), and that can be centrally maintained, including a simultaneous update for the whole considered blocks. This unitary and modular structure allows to add to the four existing blocks B, one or several other blocks of data elements, for example a block of geographic locations, operating like the others do, without any heavy reorganization of the already present recorded data, or of the programs in service, therefore with a minimum effort.

A common application is the one allowing, thanks to a single command on an initial document, presented as a summary, to view all of the folders to which it belongs, the periods to which it refers, and all of the actors concerning it.

Another common application allows, from this visualization as described above, by simultaneously pressing a modification button such as for example the button <<alt>>, to visualize, as summarized elements, the different documents resembling to the initial document (that is to say the target elements of this initial document by the link <<resembling to>>), all of the folders to which they belong (that is to say the target elements of these documents by the link <<belongs to>>), the periods to which they refer (that is to say the target periods of these documents by the link <<contains some documents from>>) and all of the actors concerning them (that is to say the target actors of these documents by the link <<concerns>>). Therefore it is easy to provide, with a minimal use of the keyboard, an answer to the question: <<What are the documents resembling to a given document, where are they filed, when do they date from, and who do they concern?>>. This question can also be expressed less precisely <<When and with whom have we handled similar topics, where is it filed, and what are the details of it?>>

Another application consists of for example choosing the link <<has been visualized during the period>> as a link between documents and periods, for example by choice of the links of type <<has a date in>> which type of date is <<date of first visualization>>. This allows the execution of a research based upon this link, thanks to a single command, and with all the easiness of a familial navigation. Therefore it is possible to answer a question of the type: <<What are the documents that have been visualized during a specific period>> then to restrict the field of vision by folders or actor, until achieving to identify the single or several pertinent documents. This functionality is peculiarly useful while browsing the internet pages with a format HTML, loaded in a cache, as one goes along the connections to the Internet network through a HTML browse such as for example Internet Explorer (registered trademark). Once these pages have been found, it is possible to change them into some permanent documents and to assign them by links to one or several folders or actors.

1. Format for data recording in a computer memory (M), in which a multiplicity of data elements (E) respectively associated with a multiplicity of data element identifiers (IE) are defined,
the format being characterized by metadata comprising at least one recorded link (L) of a first identifier (IEO) of a first data element, called source element, to a second identifier (IEC) of a second data element, called target element, this link (L) being associated to a link identifier (IL) recorded in association with the source element identifier (IEO) and with the target element identifier (IEC) in at least one link recording centralized table (TB),
at least two types of links (TL) being implemented,
each link recording centralized table (TB) comprising, at least for a set of several links (L4, L6, L7, L8) having a same source element identifier (IE7) and a same type of links (1), some hierarchical order numbers (H, 1, 2, 3) respectively recorded with the identifiers (IL4) of the links (L4, L6, L7) of said set,
each link recording centralized table (TB) being able to be interrogated by request (R2) about each source element identifier (IEO) according to one determined of the types (TL) of links, in order to access in memory (M) to the data elements associated with the target element identifiers (IEO) corresponding to this source element identifier (IEO) in at least one link (L) having the same determined type of link (TL), according to an order defined by the hierarchical order numbers (H, 1, 2, 3) of this determined type of link (TL).

2. Data recording format according to claim 1, characterized by the fact that
for at least one type of links (TL1), to each link (L1) recorded from a first source element (IEO1) to a second target element (IEC1) having this type of links (TL1), another recorded link (L12) corresponds, called reciprocal link, having another type (TL1′) of links, from this second element (IEC1) which is source for the reciprocal link (L12), to this first element (IEO1) which is target for the reciprocal link (L12).

3. Data recording format according to any one of the previous claims, characterized by the fact that at least one link is recorded with some attached data (DATT) in the recording table (TB).

4. Data recording format according to any one of the previous claims, characterized by the fact that
it comprises a plurality of modular blocks (B1, B2, B3) of attached data elements and, for each modular block (B1, B2, B3), the link recording centralized table (TB) whose source element identifier (IEO) is an identifier (IE) of a data element (E) attached to this modular block (B1, B2, B3).

5. Data recording format according to any one of the previous claims, characterized by the fact that
each data element (E) is attached to a modular block among a plurality of modular blocks (B1, B2, B3), and
the link recording centralized table (TB) comprises, recorded in association with each link identifier (IL), an identifier (IBO) of the attachment block of the target element of this link (L).

6. Data recording format according to any one of the previous claims, characterized by the fact that
each data element (E) is associated to a recorded semantic identifier (IS) and is attached to a modular block recorded among a plurality of modular blocks (B1, B2, B3), and
each modular block (B1, B2, B3) has its own predefined structure of control of screen display, to display the modular block with the same type of display for each data element (E) attached to this modular block (B1, B2, B3), whereby this type of display provides the display of at least one data field, which is predetermined from each data element (E) and which comprises at least the semantic identifier (IS) of this data element (E).

7. Data recording format according to claim 6, characterized by the fact that
each modular block (B1, B2, B3) contains several different types of display and a zone (ZDT) of selection of display type among those associated to this modular block (B1, B2, B3),
the structure of control of screen display, specific to each modular block (B1, B2, B3), being able to display each data element (E) attached to this modular block (B1, B2, B3) according to the type of display of the selection zone (ZTA).

8. Data recording format according to any one of the previous claims, characterized by the fact that
each data element (E) is attached to a modular block recorded among a plurality of modular blocks (B1, B2, B3),
whereby each modular block (B1, B2, B3) comprises means (IS) to access to each data element (E) attached to this modular block (B1, B2, B3).

9. Data recording format according to claim 8, characterized by the fact that
each data element (E) is attached to a modular block recorded among a plurality of modular blocks (B1, B2, B3),
each modular block (B1, B2, B3) comprising means (IS) to access to at least one data element (E) having as identifier (IE) the target element identifier (IEC) of at least one link (L), whose source element identifier (IEO) is the identifier of a data element attached to this modular block (B1, B2, B3).

10. Data recording format according to any one of the previous claims, characterized by the fact that
the links are semantic.

11. Data recording format according to claim 10 associated with any of the claims 4 to 9, characterized by the fact that
each data element (E) is associated to a recorded semantic identifier (IS) and is attached to a modular block recorded among a plurality of modular blocks (B1, B2, B3),
the data elements (E) arrached to each modular block (B1, B2, B3) are of a same individual semantic category, associated to this modular block (B1, B2, B3),
in association with at least one combination of several modular blocks (B1, B2, B3) and for at least one type of links (TL), a predetermined text body is recorded, comprising as variables some semantic identifiers (IS) of the data elements (E) of the respective blocks of the combination and able to be printed with, instead of the variables, the semantic identifiers (IS) of the data elements (E) of the blocks of this combination, associated to some source and target elements (IEO, IEC) of a sequence of links (L) of the recording table (TB).

12. Method to record data in a computer memory (M), in which a multiplicity of data elements (E) respectively associated with a multiplicity of data element identifiers (IE) are defined,
characterized by the fact that the data elements (E) are recorded in the memory (M) with at least one link (L) recorded in a link recording centralized table (TB) with the format according to any of claims 1 to 11,
each link (L) being able to be interrogated by request (R2) about its source element identifier (IEO), in order to automatically access in the memory to at least one data element (E) associated with the target element identifier (IEC) corresponding to this source element identifier (IEO) in the link (L).

13. Data recording method according to claim 12,
characterized by the fact that
at least one link (L) is created and/or modified in the link recording centralized table by a machine interface (I), able to be controlled by the user.

14. Data recording method according to claim 12 or 13, characterized by the fact that
at least one preemptive link (L) is automatically created by means of semantic proximity measurement applied to the data elements (E) and is automatically presented to the user on a machine interface (I), the interface (I) comprising means to manually activate a control of acceptance or refusal of creation of the presented preemptive link (L),
whereby the receipt by the interface (I) of an acceptance control for a preemptive link automatically involves the recording of this preemptive link (L) in the link recording centralized table (TB).

15. Data recording method according to any one of claims 12 to 14, characterized by the fact that
at least one link (L) is automatically created by means of semantic proximity measurement applied to the data elements (E) and is automatically recorded in the link recording centralized table (TB).

16. Data recording method according to any one of claims 12 to 15, characterized by the fact that
at least one virtual link (L), connecting a source element to a target element, or at least one virtual data element (E), defined by a determinist calculation rule, without being permanently recorded in memory, is provided, whereby the record in memory being exclusively executed by the activation of a corresponding recording control of the virtual link or of the virtual element.

17. Method to read data recorded in a computer memory (M), in which a multiplicity of data elements (E) respectively associated with a multiplicity of data element identifiers (EI) are defined, characterized by the fact that, the multiplicity of data elements (E) being recorded in the memory with at least one link (L) recorded in a link recording centralized table (TB) with the format according to any one of claims 1 to 11,
the reading access in the memory (M) to at least one first data element (E7) whose identifier (IE7) is a source element identifier (IEC) which is associated, in at least one link (L4, L6, L7, L8, L10) of the recording table (TB), with the target element identifier (IEC) of at least one second data element (E6, E5, E4, E8, E11) automatically activates by request on the identifier (IE7) of this first data element (E7) in the link recording table (TB), the additional access to the second data element (E6, E5, E4, E8, E11).

18. Method to search data elements among a multiplicity of data elements (E) recorded in a computer memory (M),
characterized by the fact that, the multiplicity of data elements (E) being recorded in the memory (M) with at least one link (L) recorded in a link recording centralized table (TB) with the format according to any one of claims 1 to 11,
a first data element (E7), is selected, which automatically activates, for a first search level going from the first data element (E7), by request on the identifier (IE7) of this first data element (E7) in the link recording table (TB), the access by link to at least one second data element (E6, E5, E4, E8, E11), at least when the identifier (IE7) of the first data element (E7) is a source element identifier (IEO) which is associated, in the same link (L4, L6, L7, L8, L10) of the link recording table (TB), with the target element identifier (IEC) formed by the identifier (IE6, IE5, IE4, IE8, IE 1) of the second data element (E6, E5, E4, E8, E11).

19. Data elements search method according to claim 18, characterized by the fact that
the access to the data elements (E6, E5, E4, E8, E11) automatically activates their distinctive and at least partial display on a screen (P).

20. Data elements search method according to claim 18 or 19, characterized by the fact that
the access by link to data elements is executed for a predetermined number of successive search levels that is superior or equal to two,
the access by link to a previous data element executed by a previous search level automatically activates, for the next search level, by request on the identifier (EI) of this previous data element in the link recording table (TB), the access by link to at least one next data element, at least when the previous data element identifier (IE) is a source element identifier (IEO) which is associated, in the same link (L) of the recording table (TB), to the target element identifier (IEC) formed by the next data element identifier (EI).

21. Data elements search method according to claim 20, characterized by the fact that
for at least one next search level, the data element or the data elements for which the access by link to at least one next data element is executed, is selected among the previous data elements.

22. Data elements search method according to claim 21, characterized by the fact that
said selection of the previous data element or elements for the next search level is automatically executed by means of at least one logical operator applied to at least one subset of the source elements (E) used for the previous search levels.

23. Method to transmit data recorded in a computer memory (M) to an output (S), in which a multiplicity of data elements (E) respectively associated with a multiplicity of data element identifiers (IE) are defined,
characterized by the fact that, the multiplicity of data elements (E) being recorded in the memory (M) with at least one link (L) recorded in a link recording centralized table (TB) with the format according to any one of claims 1 to 11,
at least one first data element (E7) to be transmitted to the output (S) is selected in the memory (M),
in the link recording centralized table (TB) the link(s) (L4, L6, L7, L8, L10) having as source element identifier (IEO) the identifier (IE7) of the first selected data element (E7) are automatically searched,
at least the link(s) (L4, L6, L7, L8, L10) found by said search are automatically transmitted to the output (S), with the first selected data element (E7).

24. Method to transmit data according to claim 23,
characterized by the fact that
the data element(s) (E6, E5, E4, E8, E11) having the target element identifier (IEC) of the link(s) (L4, L6, L7, L8, L10) found by said search are automatically transmitted to the output (S) with the first selected data element (E7) in addition to the link(s) (L4, L6, L7, L8, L10) found by said search.

25. Method to update a remote computer memory (MD) from data recorded in at least one local computer memory (M), whereby a multiplicity of data elements (E) respectively associated with a multiplicity of data elements identifiers (EI) are defined in the remote computer memory (MD) and in the local computer memory (M),
characterized by the fact that, the multiplicity of data elements (E) being recorded in the local computer memory (M) with at least one link (L) recorded in a link recording centralized table with the format according to any one of claims 1 to 11,
the update of at least one data element of the remote computer memory (RM) from a first data element (E7) of the local computer memory (M) involves the automatic search, in the link recording centralized table (TB) of the local computer memory (M), of the link(s) (L4, L6, L7, L8, L10) having as source element identifier (IEO) the identifier (IE7) of the first data element (E7) of the local computer memory (M) as well as the automatic update of a link recording table (TBD) of the remote computer memory (RM) from the link(s) (L4, L6, L7, L8, L10) found by said search in the link recording table (TB) of the local computer memory (M).

26. Method to print a document, in which a multiplicity of data elements (E) respectively associated with a multiplicity of data elements identifiers (EI) are defined in the remote computer memory (RM) and in the local computer memory (M),
characterized by the fact that, the multiplicity of data elements (E) being recorded in the local computer memory (M) with at least one link (L) recorded in a link recording centralized table (TB) with the format according to any one of claims 1 to 11,
each data element (E) is associated to a recorded semantic identifier (IS) and is attached to a modular block recorded among a plurality of modular blocks (B1, B2, B3),
the data elements (E) attached to each modular block (B1, B2, B3) are of a same individual semantic category, associated with this modular block (B1, B2, B3),
in association with at least one combination of several modular blocks (B1, B2, B3) and for at least one type of links (LT), a predetermined text body is recorded, comprising as variables some semantic identifiers (SI) of the data elements (E) of the respective blocks of the combination,
at least one first data element (E7) is selected in a block (B1) of said combination and at least another data element (E6, E9) having a link (L4) or a sequence of links (L4, L5) to the first selected data element (E7) is selected in each one of the other blocks (B2, B3) of the said combination,
the document with the text body having, instead of the variables, the semantic identifiers (IS7, IS6, IS9) of the data elements (E) selected from the blocks (B1, B2, B3) of said combination is printed.
